(19) United States
(12) Patent Application Publication
(10) Pub. No.: US 2019/0392002 A1
(43) Pub. Date: Dec. 26, 2019

(54) SYSTEMS AND METHODS FOR ACCELERATING DATA OPERATIONS BY UTILIZING DATAFLOW SUBGRAPH TEMPLATES

(71) Applicant: BigStream Solutions, Inc., Mountain View, CA (US)

(72) Inventors: Maysam Lavasani, Los Altos, CA (US); John David Davis, San Francisco, CA (US); Danesh Tavana, Los Altos, CA (US); Weiwei Chen, Mountain View, CA (US); Balavinayagam Samynathan, Mountain View, CA (US); Behnam Robatmili, San Jose, CA (US)

(73) Assignee: BigStream Solutions, Inc., Mountain View, CA (US)

(21) Appl. No.: 16/452,046

(22) Filed: Jun. 25, 2019

Related U.S. Application Data
(60) Provisional application No. 62/689,754, filed on Jun. 25, 2018.

(51) Int. Cl. G06F 16/901; G06F 8/41; G06N 20/00

(52) U.S. Cl. CPC G06F 16/9024; G06N 20/00; G06F 8/41

(57) ABSTRACT

Methods and systems are disclosed for accelerating big data operations by utilizing subgraph templates. In one example, a data processing system includes a data processing system comprising a hardware processor and a hardware accelerator coupled to the hardware processor. The hardware accelerator is configured with a compiler of an accelerator functionality to generate an execution plan, to generate computations for nodes including subgraphs in a distributed system for an application program based on the execution plan, and to execute a matching algorithm to determine similarities between the subgraphs and unique templates from an available library of templates.

### RELATED APPLICATIONS

This application claims the benefit of U.S. Provisional Application No. 62/689,754, filed on Jun. 25, 2018, the entire contents of this Provisional application is hereby incorporated by reference.

### TECHNICAL FIELD

Embodiments described herein generally relate to the field of data processing, and more particularly relates to methods and systems for accelerating big data operations by utilizing subgraph templates.

### BACKGROUND

Conventionally, big data is a term for data sets that are so large or complex that traditional data processing applications are not sufficient. Challenges of large data sets include analysis, capture, data curation, search, sharing, storage, transfer, visualization, querying, updating, and information privacy.

### SUMMARY

For one embodiment of the present invention, methods and systems for accelerating big data operations by utilizing subgraph templates are disclosed. In one embodiment, methods and systems are disclosed for accelerating big data operations by utilizing subgraph templates. In one example, a data processing system includes a hardware processor and a hardware accelerator coupled to the hardware processor. The hardware accelerator is configured with a compiler of an accelerator functionality to generate an execution plan, to generate computations for nodes including subgraphs in a distributed system for an application program based on the execution plan, and to execute a matching algorithm to determine similarities between the subgraphs and unique templates from an available library of templates.

Other features and advantages of embodiments of the present invention will be apparent from the accompanying drawings and from the detailed description that follows below.

### BRIEF DESCRIPTION OF THE DRAWINGS

FIG. 1 shows an embodiment of a block diagram of a big data system 100 for providing big data applications for a plurality of devices in accordance with one embodiment.

FIG. 2 is a flow diagram illustrating a method 200 for accelerating big data operations by utilizing subgraph templates according to an embodiment of the disclosure.

FIG. 3 is a flow diagram illustrating a method 300 for runtime flow of big data operations by utilizing subgraph templates according to an embodiment of the disclosure.

FIG. 4 shows an embodiment of a block diagram of an accelerator architecture for accelerating big data operations by utilizing subgraph templates in accordance with one embodiment.

FIG. 5 illustrates the schematic diagram of a data processing system according to an embodiment of the present invention.

FIG. 6 illustrates the schematic diagram of a multi-layer accelerator according to an embodiment of the invention.

FIG. 7 is a diagram of a computer system including a data processing system according to an embodiment of the invention.

### DETAILED DESCRIPTION OF EMBODIMENTS

Methods, systems and apparatuses for accelerating big data operations by utilizing subgraph templates are described.

In the following description, for purposes of explanation, numerous specific details are set forth in order to provide a thorough understanding of the present invention. It will be apparent, however, to one skilled in the art that the present invention can be practiced without these specific details. In other instances, well-known structures and devices are shown in block diagram form in order to avoid obscuring the present invention.

Reference in the specification to “one embodiment” or “an embodiment” means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

The following glossary of terminology and acronyms serves to assist the reader by providing a simplified quick-reference definition. A person of ordinary skill in the art may understand the terms as used herein according to general usage and definitions that appear in widely available standards and reference books.

HW: Hardware.

SW: Software.

I/O: Input/Output.

DMA: Direct Memory Access.

CPU: Central Processing Unit.

FPGA: Field Programmable Gate Arrays.

CGRA: Coarse-Grain Reconfigurable Accelerators.

GPGPU: General-Purpose Graphical Processing Units.

MLWC: Many Light-weight Cores.

ASIC: Application Specific Integrated Circuit.

PCIe: Peripheral Component Interconnect express.

CDFG: Control and Data-Flow Graph.

FIFO: First In, First Out

NIC: Network Interface Card

HLS: High-Level Synthesis

KPN: Kahn Processing Networks (KPN) is a distributed model of computation (MoC) in which a group of deterministic sequential processes are communicating through unbounded FIFO channels. The process network exhibits deterministic behavior that does not depend on various computation or communication delays. A KPN can be mapped onto any accelerator (e.g., FPGA based platform) for embodiments described herein.

Dataflow analysis: An analysis performed by a compiler on the CDFG of the program to determine dependencies between a write operation on a variable and the consequent operations which might be dependent on the written operation.

Accelerator: a specialized HW/SW component that is customized to run an application or a class of applications efficiently.

In-line accelerator: An accelerator for I/O-intensive applications that can send and receive data without CPU involvement. If an in-line accelerator cannot finish the processing of an input data, it passes the data to the CPU for further processing.

Bailout: The process of transitioning the computation associated with an input from an in-line accelerator to a general purpose instruction-based processor (i.e. general purpose core).

Continuation: A kind of bailout that causes the CPU to continue the execution of an input data on an accelerator right after the bailout point.

Rollback: A kind of bailout that causes the CPU to restart the execution of an input data on an accelerator from the beginning or some other known location with related recovery data like a checkpoint.

Gorilla++: A programming model and language with both dataflow and shared-memory constructs as well as a toolset that generates HW/SW from a Gorilla++ description.

GDF: Gorilla dataflow (the execution model of Gorilla++).

GDF node: A building block of a GDF design that receives an input, may apply a computation kernel on the input, and generates corresponding outputs. A GDF design consists of multiple GDF nodes. A GDF node may be realized as a hardware module or a software thread or a hybrid component. Multiple nodes may be realized on the same virtualized hardware module or on a same virtualized software thread.

Engine: A special kind of component such as GDF that contains computation.

Infrastructure component: Memory, synchronization, and communication components.

Computation kernel: The computation that is applied to all input data elements in an engine.

Data state: A set of memory elements that contains the current state of computation in a Gorilla program.

Control State: A pointer to the current state in a state machine, stage in a pipeline, or instruction in a program associated to an engine.

Dataflow token: Components input/output data elements.

Kernel operation: An atomic unit of computation in a kernel. There might not be a one to one mapping between kernel operations and the corresponding realizations as states in a state machine, stages in a pipeline, or instructions running on a general purpose instruction-based processor.

Accelerators can be used for many big data systems that are built from a pipeline of subsystems including data collection and logging layers, a Messaging layer, a Data ingestion layer, a Data enrichment layer, a Data store layer, and an Intelligent extraction layer. Usually data collection and logging layer are done on many distributed nodes. Messaging layers are also distributed. However, ingestion, enrichment, storing, and intelligent extraction happen at the central or semi-central systems. In many cases, ingestions and enrichments need a significant amount of data processing. However, large quantities of data need to be transferred from event producers, distributed data collection and logging layers and messaging layers to the central systems for data processing.

Examples of data collection and logging layers are web servers that are recording website visits by a plurality of users. Other examples include sensors that record a measurement (e.g., temperature, pressure) or security devices that record special packet transfer events. Examples of a messaging layer include a simple copying of the logs, or using more sophisticated messaging systems (e.g., Kafka, Nifi). Examples of ingestion layers include extract, transform, load (ETL) tools that refer to a process in a database usage and particularly in data warehousing. These ETL tools extract data from data sources, transform the data for storing in a proper format or structure for the purposes of querying and analysis, and load the data into a final target (e.g., database, data store, data warehouse). An example of a data enrichment layer is adding geographical information or user data through databases or key value stores. A data store layer can be a simple file system or a database. An intelligent extraction layer usually uses machine learning algorithms to learn from past behavior to predict future behavior.

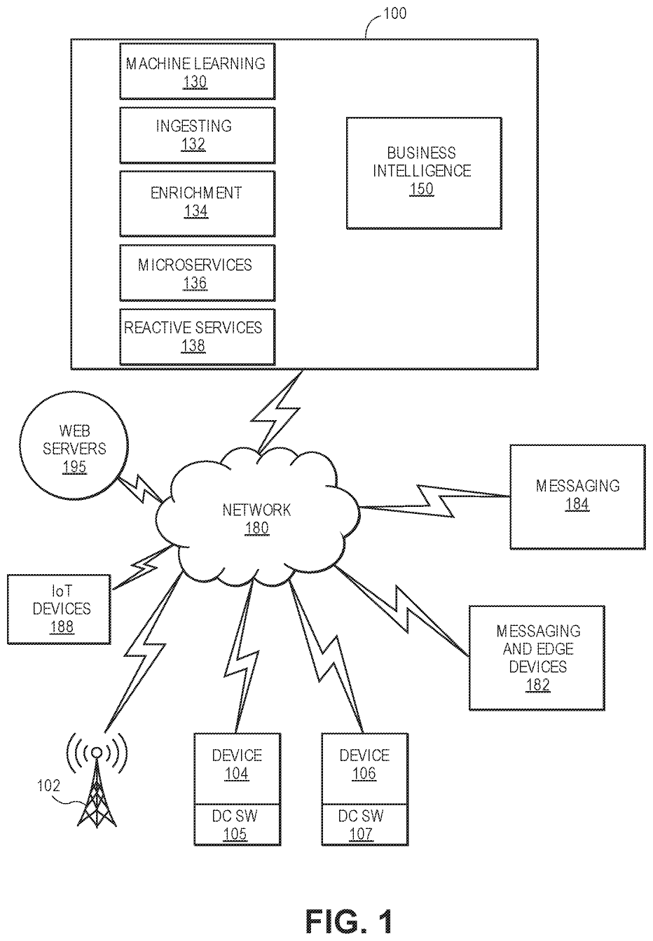

FIG. 1 shows an embodiment of a block diagram of a big data system 100 for providing big data applications for a plurality of devices in accordance with one embodiment. The big data system 100 includes machine learning modules 130, ingestion layer 132, enrichment layer 134, microservices 136 (e.g., microservice architecture), reactive services 138, and business intelligence layer 150. In one example, a microservice architecture is a method of developing software applications as a suite of independently deployable, small, modular services. Each service has a unique process and communicates through a lightweight mechanism. The system 100 provides big data services by collecting data from messaging systems 182 and edge devices, messaging systems 184, web servers 195, communication modules 102, internet of things (IoT) devices 186, and devices 104 and 106 (e.g., source device, client device, mobile phone, tablet device, lap top, computer, connected or hybrid television (TV), IPTV, Internet TV, Web TV, smart TV, satellite device, satellite TV, automobile, airplane, etc.). Each device may include a respective big data application 105, 107 (e.g., a data collecting software layer) for collecting any type of data that is associated with the device (e.g., user data, device type, network connection, display orientation, volume setting, language preference, location, web browsing data, transaction type, purchase data, etc.). The system 100, messaging systems and edge devices 182, messaging systems 184, web servers 195, communication modules 102, internet of things (IoT) devices 186, and devices 104 and 106 communicate via a network 180 (e.g., Internet, wide area network, cellular, Wi-Fi, WiMax, satellite, etc.).

The present design automatically provides novel templates for performing frequently used functions (e.g., filter, project, join, map, sort) for common patterns in subgraphs of big data operations. In one example, a template includes multiple functions to reduce communications between a CPU and FPGA and also minimize or eliminate HLS. For example, a first template includes at least two of these functions (e.g., filter, project, inner/outer join, map, sort) and a second template includes at least three of these functions. These templates with multiple functions reduce a number of communications between CPU and FPGA in which the CPU sends data to the FPGA, programmable logic performs functionality, and then sends a result for each operand to the CPU.

A template of the present design (e.g., dataflow subgraph template) is a data structure with a link in which said link has a unique name with a pointer to a unique FPGA bit file, core FPGA image, or GPU kernel. The bit file or image has a circuit implementation for executing and accelerating a subgraph of an application program in FPGA hardware. The designated subgraph of the application program is obtained from a Directed Acyclic Graph (DAG) or a subset of DAG of typical distributed systems like Spark, and subsequently re-directed to an optimum execution unit like a CPU, FPGA, or GPU.

An FPGA accelerator hardware implementation can have functionality that is a superset (more) of the subgraph, an exact match or a subset of the subgraph. When it is a subset of the subgraph functionality, other computation units like the CPU and/or GPU complete the subgraph. When the hardware implementation has a superset of the subgraph, only the specific subset of the FPGA functions needed are used to complete the task. The optimal execution unit can be one or more of execution units for sequential or parallel execution.

Templates can further be customized based on run-time information about the workload. A single template can be reused for a variety of different applications that employ the same subgraph within an application. Templates are hardware bit files that are software configurable. These configurations or software personalities enable reuse across multiple applications.

In one embodiment, a template library is a collection of dataflow subgraph templates that are stored in a database or in another data structure. Certain set of subgraphs in a generic form is enough to execute a large number of real world applications. This library provides the ability to run majority of applications in distributed frameworks.

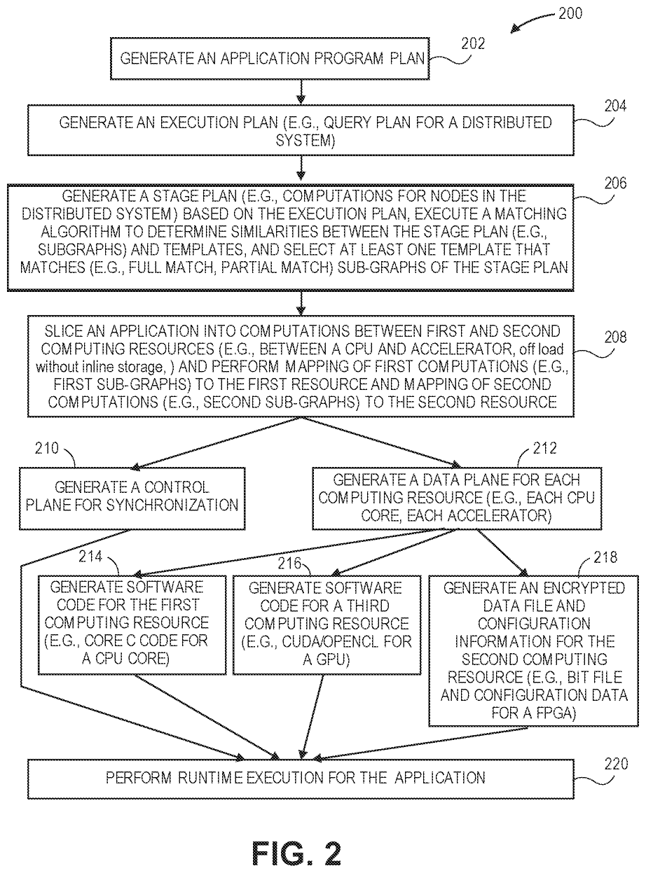

FIG. 2 is a flow diagram illustrating a method 200 for accelerating big data operations by utilizing subgraph templates according to an embodiment of the disclosure. Although the operations in the method 200 are shown in a particular order, the order of the actions can be modified. Thus, the illustrated embodiments can be performed in a different order, and some operations may be performed in parallel. Some of the operations listed in FIG. 2 are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of method 200 may be executed by a compiler component, a data processing system, a machine, a server, a web appliance, a centralized system, a distributed node, or any system, which includes an in-line accelerator. The in-line accelerator may include hardware (circuitry, dedicated logic, etc.), software (such as is run on a general purpose computer system or a dedicated machine or a device), or a combination of both. In one embodiment, a compiler component performs the operations of method 200.

At operation 202, the method includes generating an application program plan. At operation 204, the method includes generating an execution plan (e.g., query plan for a distributed system). In one example, a distributed system (e.g., Spark) performs operations 202 and 204. At operation 206, the method generates a stage plan (e.g., computations for nodes in the distributed system) for the application program based on the execution plan, executes a matching algorithm to determine similarities between the stage plan (e.g., subgraphs) and unique templates from an available library of templates, and selects at least one template that matches (e.g., full match, partial match) sub-graphs of the stage plan. At operation 208, the method slices an application into computations between first and second computing resources (e.g., between a first execution unit and a second execution unit, between a CPU and in-line accelerator) and performs mapping of first computations (e.g., first subgraphs) to the first resource and mapping of second computations (e.g., second subgraphs) to the second resource. In one example of operation 208, a compiler generates a linear stage trace (LST) with a LST being a linear subgraph of the DAG or data-flow graph. The present design is not restricted to linear graphs and can operate on any kind of Directed Acyclic Graph (DAG). The compiler matches the stage plan to unique templates from an available library of templates, then generates FPGA, GPU and/or CPU specific control and data information for runtime execution flow by utilizing selected templates.

At operation 210, the method generates a control plan for synchronization. At operation 212, the method generates a data plane for each computing resource (e.g., each CPU core, each accelerator). At operation 214, the method generates software code for the first computing resource (e.g., core C code for a CPU core). At operation 216, the method generates software code for a third computing resource (e.g., CUDA/OpenCL for a GPU). At operation 218, the method generates an encrypted data file and configuration information for the second computing resource (e.g., BIT file and configuration data for a FPGA). At operation 220, the method performs runtime execution for the application (e.g., big data application). In one example, a data flow compiler may perform operations 206-218.

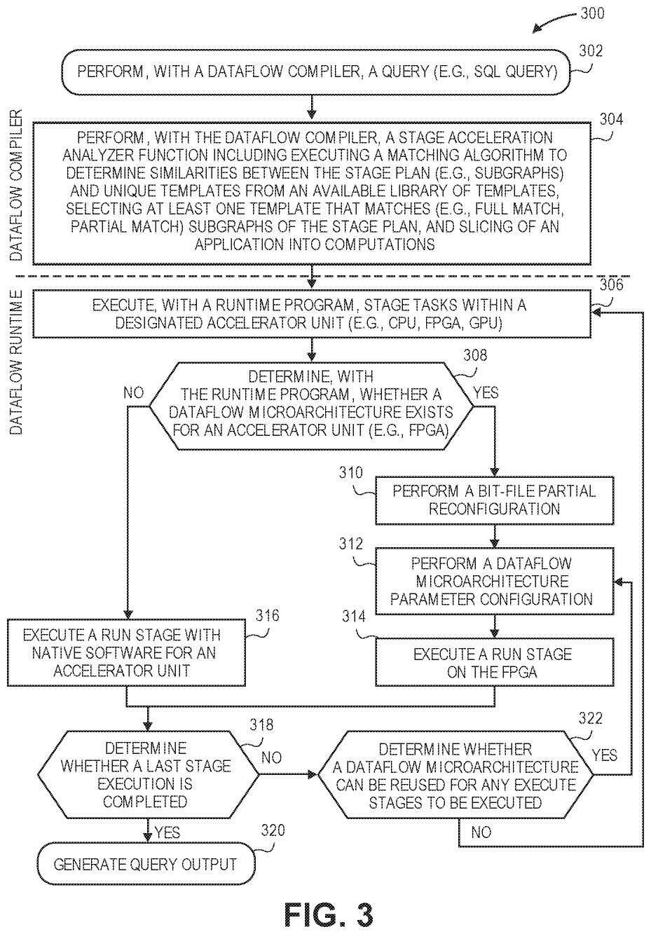

FIG. 3 is a flow diagram illustrating a method 300 for runtime flow of big data operations by utilizing subgraph templates according to an embodiment of the disclosure. Although the operations in the method 300 are shown in a particular order, the order of the actions can be modified. Thus, the illustrated embodiments can be performed in a different order, and some operations may be performed in parallel. Some of the operations listed in FIG. 3 are optional in accordance with certain embodiments. The numbering of the operations presented is for the sake of clarity and is not intended to prescribe an order of operations in which the various operations must occur. Additionally, operations from the various flows may be utilized in a variety of combinations.

Upon receiving FPGA, GPU or CPU specific control and data information from a data flow compiler of the present design, a runtime program executes the stage tasks inside the designated accelerator unit (e.g., CPU, FPGA, GPU) until the last stage is completed. The initial execution of an FPGA accelerated function within a stage requires bit-file partial reconfiguration (e.g., operation 310). This typically takes milliseconds. After the initial bit-file is downloaded, all subsequent application specific selectable parameters (e.g., filter values) are configured (e.g., operation 312) without requiring a bit-file partial reconfiguration. Parameter configurations or software personalities enable reuse across multiple applications. Data flow execution runs in a loop according to the control information until the last stage execution is completed.

At operation 302, a dataflow compiler performs a query (e.g., SQL query). At operation 304, dataflow compiler performs a stage acceleration analyzer function including executing a matching algorithm to determine similarities between the stage plan (e.g., sub-graphs) and unique templates from an available library of templates, selecting at least one template that matches (e.g., full match, partial match) sub-graphs of the stage plan, and slicing of an application into computations. At operation 306, a runtime program executes stage tasks within a designated accelerator unit (e.g., CPU, FPGA, GPU). At operation 308, the runtime program determines whether a dataflow microarchitecture exists for an accelerator unit (e.g., FPGA).

If so, then the runtime program performs a bit-file partial reconfiguration at operation 310. At operation 312, the runtime program performs a dataflow microarchitecture parameter configuration. At operation 314, the runtime program executes a run stage on the FPGA.

If no dataflow microarchitecture exists, then the runtime program executes a run stage with native software for an accelerator unit at operation 316. At operation 318, the runtime program determines whether a last stage execution is completed. If so, then the method proceeds to generate query output at operation 320. If not, then the method proceeds to determine whether a dataflow microarchitecture can be reused at operation 322 for any execute stages to be executed. If so, then the method proceeds to operation 312. If not, then the method returns to operation 306.

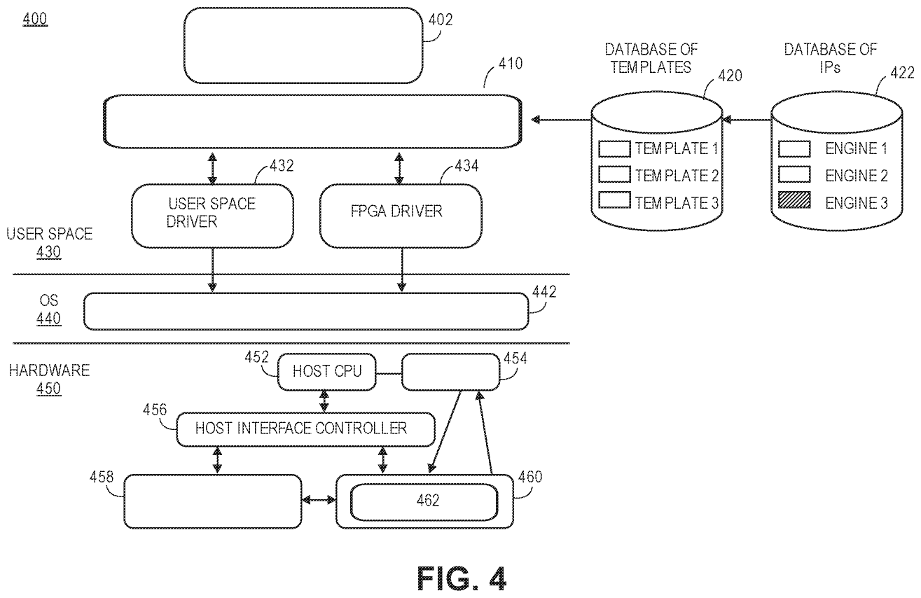

FIG. 4 shows an embodiment of a block diagram of an accelerator architecture for accelerating big data operations by utilizing subgraph templates in accordance with one embodiment. An accelerator architecture 400 (e.g., data processing system) includes an analytics engine 402 for large scale data processing, an acceleration functionality 410, a database of templates 420, and a database of intellectual property (IP) engines 422. A user space 430 includes an optional user space driver 432 (e.g., user space network adapter, user space file system) and a software driver 434 (e.g., FPGA driver). An operating system (OS) 440 includes a software driver 442 (e.g., NVMe/PCIe driver). Hardware 450 of the accelerator architecture includes a Host CPU 452, memory 454 (e.g., host DRAM), a host interface controller 456, a solid-state storage device 458, and an accelerator 460 (e.g., FPGA 460) having configurable design 462.

The accelerator architecture 400 provides an automated template discovery with creation and deployment methodology being used to provide additional templates and IP Engines (e.g., bit files) for an ever expanding database of template libraries.

In one example, a compiler component of acceleration functionality 410 identifies and loads FPGA bitstream based on an acceleration template match between an input subgraph and matching acceleration template of the database of templates 420.

The present design utilizes smart pattern matching from Application DAG to Hardware Templates with efficient cost functions. DAG template matching algorithms operate on a Directed Acyclic Graph that is typically used in distributed systems like SQL based analytic engines. The DAG template matching algorithms optimally assign the designated slices of the application program to a unique template within a library of templates. The algorithms utilize cost functions (e.g., performance, power, price, locality of data vs. accelerator, latency, bandwidth, data source, data size, operator selectivity based on sampling or history, data shape, etc. . . . ) to assign a slice of DAG to a template. Other standard cost functions can be system or user defined, and can be based on total stage runtime vs task run time. In such cases part of the graph will execute on the CPU, the rest on the accelerator.

Partial subgraph matches execute on an accelerator based on a cost function that optimizes the system and use either full or partial matches based on run time and historical information. A subgraph matches to a template. A template might include multiple engines. An engine can function as a generic operator or node in the graph. A subgraph might partially match with template. In such cases part of the graph will execute on the CPU, the rest on the accelerator.

Next, the acceleration functionality 410 performs a software configuration of a FPGA to customize a hardware template for an application. The acceleration functionality 410 then issues an “accelerated” compute task and this requires input/output requests to the device 458. Input data is copied from a host CPU 452 to memory of the FPGA 460 and back again to an application user space memory to complete this process for accelerating big data applications by utilizing acceleration templates.

Field software upgrades provide more operators and functionality enhancements to a current library of an accelerator. Feature discovery for new Engines and Templates happens by profiling the application and accumulating a history of profiles. Next, cost-based targeted optimization is used to realize the highest acceleration opportunities, followed by automated, offline template creation with automatic template library upgrades. Engines can be third party IP or internal IP. For 3rd party IP, the present design can meter to enable charge back.

An accelerator functionality 410 of the present design is agnostic to the specific physical locality of the FPGA within the overall system architecture. The accelerator functionality can be attached as an add-on card to the host server, embedded into the storage subsystem, or into the network interface, or it can be a remote server/client for near the edge IOT application.

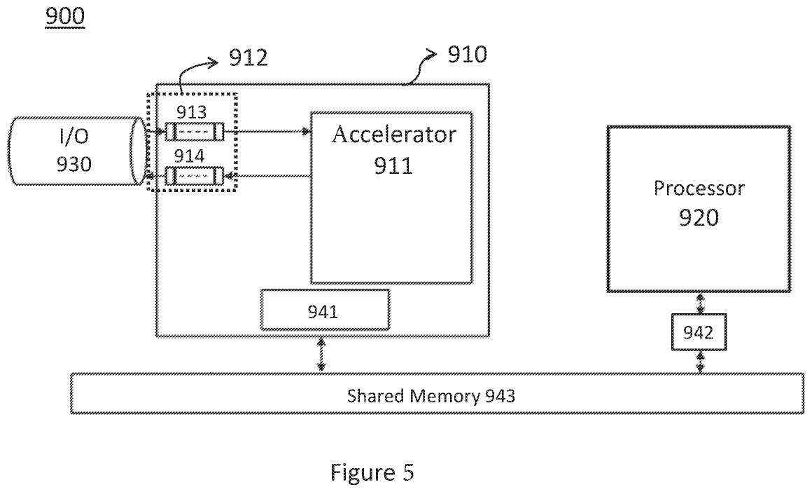

FIG. 5 illustrates the schematic diagram of data processing system 900 according to an embodiment of the present invention. Data processing system 900 includes I/O processing unit 910 and general purpose instruction-based processor 920. In an embodiment, general purpose instruction-based processor 920 may include a general purpose core or multiple general purpose cores. A general purpose core is not tied to or integrated with any particular algorithm. In an alternative embodiment, general purpose instruction-based processor 920 may be a specialized core. I/O processing unit 910 may include an accelerator 911 (e.g., in-line accelerator, offload accelerator for offloading processing from another computing resource, or both). In-line accelerators are a special class of accelerators that may be used for I/O intensive applications. Accelerator 911 and general purpose instruction-based processor may or may not be on a same chip. Accelerator 911 is coupled to I/O interface 912. Considering the type of input interface or input data, in one embodiment, the accelerator 911 may receive any type of network packets from a network 930 and an input network interface card (NIC). In another embodiment, the accelerator maybe receiving raw images or videos from the input cameras. In an embodiment, accelerator 911 may also receive voice data from an input voice sensor device.

In an embodiment, accelerator 911 is coupled to multiple I/O interfaces (not shown in the figure). In an embodiment, input data elements are received by I/O interface 912 and the corresponding output data elements generated as the result of the system computation are sent out by I/O interface 912. In an embodiment, I/O data elements are directly passed to/from accelerator 911. In processing the input data elements, in an embodiment, accelerator 911 may be required to transfer the control to general purpose instruction-based processor 920. In an alternative embodiment, accelerator 911 completes execution without transferring the control to general purpose instruction-based processor 920. In an embodiment, accelerator 911 has a master role and general purpose instruction-based processor 920 has a slave role.

In an embodiment, accelerator 911 partially performs the computation associated with the input data elements and transfers the control to other accelerators or the main general purpose instruction-based processor in the system to complete the processing. The term “computation” as used herein may refer to any computer task processing including, but not limited to, any of arithmetic/logic operations, memory operations, I/O operations, and offloading part of the computation to other elements of the system such as general purpose instruction-based processors and accelerators. Accelerator 911 may transfer the control to general purpose instruction-based processor 920 to complete the computation. In an alternative embodiment, accelerator 911 performs the computation completely and passes the output data elements to I/O interface 912. In another embodiment, accelerator 911 does not perform any computation on the input data elements and only passes the data to general purpose instruction-based processor 920 for computation. In another embodiment, general purpose instruction-based processor 920 may have accelerator 911 to take control and completes the computation before sending the output data elements to the I/O interface 912.

In an embodiment, accelerator 911 may be implemented using any device known to be used as accelerator, including but not limited to field-programmable gate array (FPGA), Coarse-Grained Reconfigurable Architecture(CGRA), general-purpose computing on graphics processing unit (GPGPU), many light-weight cores (MLWC), network general purpose instruction-based processor, I/O general purpose instruction-based processor, and application-specific integrated circuit (ASIC). In an embodiment, I/O interface 912 may provide connectivity to other interfaces that may be used in networks, storages, cameras, or other user interface devices. I/O interface 912 may include receive first in first out (FIFO) storage 913 and transmit FIFO storage 914. FIFO storages 913 and 914 may be implemented using SRAM, flip-flops, latches or any other suitable form of storage. The input packets are fed to the accelerator through receive FIFO storage 913 and the generated packets are sent over the network by the accelerator and/or general purpose instruction-based processor through transmit FIFO storage 914.

In an embodiment, I/O processing unit 910 may be Network Interface Card (NIC). In an embodiment of the invention, accelerator 911 is part of the NIC. In an embodiment, the NIC is on the same chip as general purpose instruction-based processor 920. In an alternative embodiment, the NIC 910 is on a separate chip coupled to general purpose instruction-based processor 920. In an embodiment, the NIC-based accelerator receives an incoming packet, as input data elements through I/O interface 912, processes the packet and generates the response packet(s) without involving general purpose instruction-based processor 920. Only when accelerator 911 cannot handle the input packet by itself, the packet is transferred to general purpose instruction-based processor 920. In an embodiment, accelerator 911 communicates with other I/O interfaces, for example, storage elements through direct memory access (DMA) to retrieve data without involving general purpose instruction-based processor 920.

Accelerator 911 and the general purpose instruction-based processor 920 are coupled to shared memory 943 through private cache memories 941 and 942 respectively. In an embodiment, shared memory 943 is a coherent memory system. The coherent memory system may be implemented as shared cache. In an embodiment, the coherent memory system is implemented using multiples caches with coherency protocol in front of a higher capacity memory such as a DRAM.

In an embodiment, the transfer of data between different layers of accelerations may be done through dedicated channels directly between accelerator 911 and processor 920. In an embodiment, when the execution exits the last acceleration layer by accelerator 911, the control will be transferred to the general-purpose core 920.

Processing data by forming two paths of computations on accelerators and general purpose instruction-based processors (or multiple paths of computation when there are multiple acceleration layers) have many other applications apart from low-level network applications. For example, most emerging big-data applications in data centers have been moving toward scale-out architectures, a technology for scaling the processing power, memory capacity and bandwidth, as well as persistent storage capacity and bandwidth. These scale-out architectures are highly network-intensive. Therefore, they can benefit from acceleration. These applications, however, have a dynamic nature requiring frequent changes and modifications. Therefore, it is highly beneficial to automate the process of splitting an application into a fast-path that can be executed by an accelerator with subgraph templates and a slow-path that can be executed by a general purpose instruction-based processor as disclosed herein.

While embodiments of the invention are shown as two accelerated and general-purpose layers throughout this document, it is appreciated by one skilled in the art that the invention can be implemented to include multiple layers of computation with different levels of acceleration and generality. For example, a FPGA accelerator can backed by a many-core hardware. In an embodiment, the many-core hardware can be backed by a general purpose instruction-based processor.

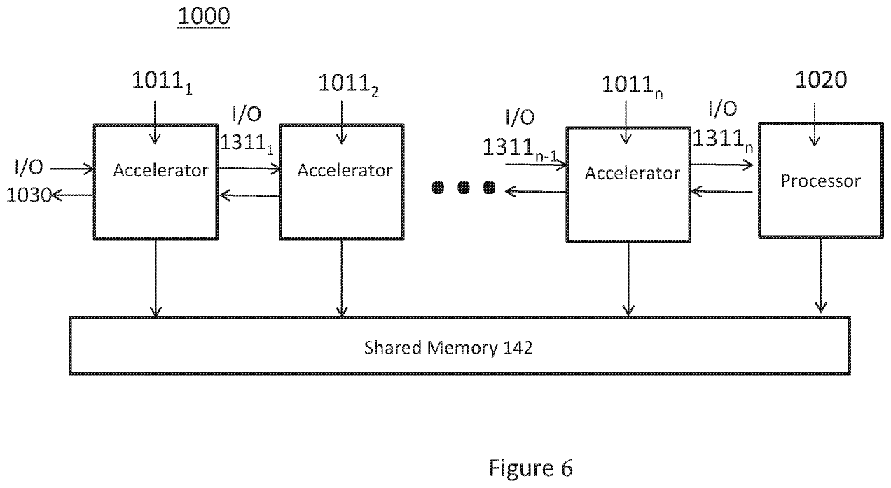

Referring to FIG. 6, in an embodiment of invention, a multi-layer system 1000 that utilizes subgraph templates is formed by a first accelerator 1011₁ (e.g., in-line accelerator, offload accelerator for offloading processing from another computing resource, or both) and several other accelerators 1011ₙ (e.g., in-line accelerator, offload accelerator for offloading processing from another computing resource, or both). The multi-layer system 1000 includes several accelerators, each performing a particular level of acceleration. In such a system, execution may begin at a first layer by the first accelerator 1011₁. Then, each subsequent layer of acceleration is invoked when the execution exits the layer before it. For example, if the accelerator 1011₁ cannot finish the processing of the input data, the input data and the execution will be transferred to the next acceleration layer, accelerator 1011₂. In an embodiment, the transfer of data between different layers of accelerations may be done through dedicated channels between layers (e.g., 1311₁ to 1311ₙ. In an embodiment, when the execution exits the last acceleration layer by accelerator 1011ₙ, the control will be transferred to the general-purpose core 1020.

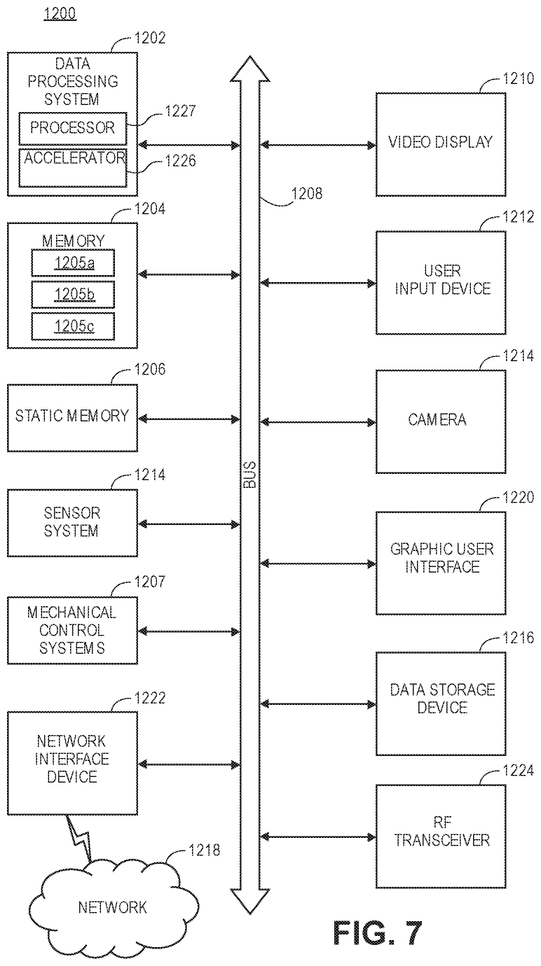

FIG. 7 is a diagram of a computer system including a data processing system that utilizes subgraph templates according to an embodiment of the invention. Within the computer system 1200 is a set of instructions for causing the machine to perform any one or more of the methodologies discussed herein. In alternative embodiments, the machine may be connected (e.g., networked) to other machines in a LAN, an intranet, an extranet, or the Internet. The machine can operate in the capacity of a server or a client in a client-server network environment, or as a peer machine in a peer-to-peer (or distributed) network environment, the machine can also operate in the capacity of a web appliance, a server, a network router, switch or bridge, event producer, distributed node, centralized system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

Data processing system 1202, as disclosed above, includes a general purpose instruction-based processor 1227 and an accelerator 1226 (e.g., in-line accelerator, offload accelerator for offloading processing from another computing resource, or both). The general purpose instruction-based processor may be one or more general purpose instruction-based processors or processing devices (e.g., microprocessor, central processing unit, or the like). More particularly, data processing system 1202 may be a complex instruction set computing (CISC) microprocessor, reduced instruction set computing (RISC) microprocessor, very long instruction word (VLIW) microprocessor, general purpose instruction-based processor implementing other instruction sets, or general purpose instruction-based processors implementing a combination of instruction sets. The accelerator may be one or more special-purpose processing devices such as an application specific integrated circuit (ASIC), a field programmable gate array (FPGA), a digital signal general purpose instruction-based processor (DSP), network general purpose instruction-based processor, many light-weight cores (MLWC) or the like. Data processing system 1202 is configured to implement the data processing system for performing the operations and steps discussed herein.

The exemplary computer system 1200 includes a data processing system 1202, a main memory 1204 (e.g., read-only memory (ROM), flash memory, dynamic random access memory (DRAM) such as synchronous DRAM (SDRAM) or DRAM (RDRAM), etc.), a static memory 1206 (e.g., flash memory, static random access memory (SRAM), etc.), and a data storage device 1216 (e.g., a secondary memory unit in the form of a drive unit, which may include fixed or removable computer-readable storage medium), which communicate with each other via a bus 1208. The storage units disclosed in computer system 1200 may be configured to implement the data storing mechanisms for performing the operations and steps discussed herein. Memory 1206 can store code and/or data for use by processor 1227 or accelerator 1226. Memory 1206 include a memory hierarchy that can be implemented using any combination of RAM (e.g., SRAM, DRAM, DDRAM), ROM, FLASH, magnetic and/or optical storage devices. Memory may also include a transmission medium for carrying information-bearing signals indicative of computer instructions or data (with or without a carrier wave upon which the signals are modulated).

Processor 1227 and accelerator 1226 execute various software components stored in memory 1204 to perform various functions for system 1200. In one embodiment, the software components include operating system 1205a, compiler component 1205b for executing a matching algorithm and selecting templates that at least partially match input subgraphs, and communication module (or set of instructions) 1205c. Furthermore, memory 1206 may store additional modules and data structures not described above.

Operating system 1205a includes various procedures, sets of instructions, software components and/or drivers for controlling and managing general system tasks and facilitates communication between various hardware and software components. A compiler is a computer program (or set of programs) that transform source code written in a programming language into another computer language (e.g., target language, object code). A communication module 1205c provides communication with other devices utilizing the network interface device 1222 or RF transceiver 1224.

The computer system 1200 may further include a network interface device 1222. In an alternative embodiment, the data processing system disclose is integrated into the network interface device 1222 as disclosed herein. The computer system 1200 also may include a video display unit 1210 (e.g., a liquid crystal display (LCD), LED, or a cathode ray tube (CRT)) connected to the computer system through a graphics port and graphics chipset, an input device 1212 (e.g., a keyboard, a mouse), a camera 1214, and a Graphic User Interface (GUI) device 1220 (e.g., a touch-screen with input & output functionality).

The computer system 1200 may further include a RF transceiver 1224 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/de-interleaving, spreading/dispreading, inverse fast Fourier transforming (IFFT)/fast Fourier transforming (FFT), cyclic prefix appending/removal, and other signal processing functions.

The Data Storage Device 1216 may include a machine-readable storage medium (or more specifically a computer-readable storage medium) on which is stored one or more sets of instructions embodying any one or more of the methodologies or functions described herein. Disclosed data storing mechanism may be implemented, completely or at least partially, within the main memory 1204 and/or within the data processing system 1202 by the computer system 1200, the main memory 1204 and the data processing system 1202 also constituting machine-readable storage media.

In one example, the computer system 1200 is an autonomous vehicle that may be connected (e.g., networked) to other machines or other autonomous vehicles in a LAN, WAN, or any network. The autonomous vehicle can be a distributed system that includes many computers networked within the vehicle. The autonomous vehicle can transmit communications (e.g., across the Internet, any wireless communication) to indicate current conditions (e.g., an alarm collision condition indicates close proximity to another vehicle or object, a collision condition indicates that a collision has occurred with another vehicle or object, etc.). The autonomous vehicle can operate in the capacity of a server or a client in a client-server network environment, or as a peer machine in a peer-to-peer (or distributed) network environment. The storage units disclosed in computer system 1200 may be configured to implement data storing mechanisms for performing the operations of autonomous vehicles.

The computer system 1200 also includes sensor system 1214 and mechanical control systems 1207 (e.g., motors, driving wheel control, brake control, throttle control, etc.). The processing system 1202 executes software instructions to perform different features and functionality (e.g., driving decisions) and provide a graphical user interface 1220 for an occupant of the vehicle. The processing system 1202 performs the different features and functionality for autonomous operation of the vehicle based at least partially on receiving input from the sensor system 1214 that includes laser sensors, cameras, radar, GPS, and additional sensors. The processing system 1202 may be an electronic control unit for the vehicle.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A data processing system comprising:
a hardware processor; and
a hardware accelerator coupled to the hardware processor, the hardware accelerator is configured with a compiler of an accelerator functionality to generate an execution plan, to generate computations for nodes including subgraphs in a distributed system for an application program based on the execution plan, and to execute a matching algorithm to determine similarities between the subgraphs and unique templates from an available library of templates.

2. The data processing system of claim 1, wherein the accelerator functionality to select at least one subgraph template from the library of templates to at least partially match with a subgraph in the distributed system.

3. The data processing system of claim 1, wherein the accelerator functionality to slice an application program into computations between the hardware processor and the hardware accelerator and to map first computations including first subgraphs to the hardware processor and to map second computations including second subgraphs to the hardware accelerator.

4. The data processing system of claim 1, wherein the compiler generates a linear stage trace (LST) with the LST being a linear subgraph of a Directed Acyclic Graph (DAG) or data-flow graph.

5. The data processing system of claim 1, wherein the hardware processor comprises a CPU and the hardware accelerator comprises a field programmable gate array (FPGA) or a graphics processing unit (GPU).

6. The data processing system of claim 5, wherein the compiler matches the subgraphs to unique templates from an available library of templates and then generates FPGA, GPU or CPU specific control and data information for runtime execution flow by utilizing selected templates.

7. The data processing system of claim 1, wherein the compiler generates a control plan for synchronization and generates a data plane for each computing resource including the hardware processor and the hardware accelerator.

8. A computer-implemented method for runtime flow of big data operations by utilizing subgraph templates, the method comprising:
performing a query with a dataflow compiler;
performing, with the dataflow compiler, a stage acceleration analyzer function including executing a matching algorithm to determine similarities between sub-graphs of an application program and unique templates from an available library of templates; and
selecting at least one template that at least partially matches the sub-graphs.

9. The computer-implemented method of claim 8, further comprising:
slicing of the application program into computations.

10. The computer-implemented method of claim 9, further comprising:
executing, with a runtime program, stage tasks within a designated accelerator unit.

11. The computer-implemented method of claim 10, further comprising:
determining, with the runtime program, whether a dataflow microarchitecture exists for an accelerator unit.

12. The computer-implemented method of claim 11, further comprising:
performing, with the runtime program, a bit-file partial reconfiguration when the dataflow microarchitecture exists for an accelerator unit.

13. The computer-implemented method of claim 12, further comprising:
performing, with the runtime program, a dataflow microarchitecture parameter configuration.

14. The computer-implemented method of claim 13, further comprising:
executing, with the runtime program, a run stage on the accelerator unit.

15. The computer-implemented method of claim 11, further comprising:
if no dataflow microarchitecture exists, executing, with the runtime program, a run stage with native software for an accelerator unit at operation 316.

16. The computer-implemented method of claim 11, further comprising:
determine, with the runtime program, whether a last stage execution is completed;
if last stage execution is completed, generate query output.

17. The computer-implemented method of claim 16, further comprising:
if last stage execution is not completed, determine whether a dataflow microarchitecture can be reused for any execute stages to be executed.

18. An accelerator architecture, comprising:
a host processing resource;
an analytics engine for large scale data processing;
an accelerator having acceleration functionality to identify and to load FPGA bitstream based on an acceleration template match between an input subgraph and matching acceleration template of a database of templates.

19. The accelerator architecture of claim 18, wherein the acceleration functionality is configured to utilize smart pattern matching from Directed Acyclic Graph (DAG) to hardware templates with efficient cost functions.

20. The accelerator architecture of claim 19, wherein the accelerator functionality is configured to execute DAG template matching algorithms that operate on a DAG, wherein the DAG template matching algorithms optimally assign the designated slices of an application program to a unique template within the database of templates.

21. The accelerator architecture of claim 20, wherein the template matching algorithms utilize cost functions including at least one of performance, power, price, locality of data vs. accelerator, latency, bandwidth, data source, data size, operator selectivity based on sampling or history, or data shape to assign a slice of DAG to a template.
